(19) United States
(12) Patent Application Publication
(10) Pub. No.: US 2006/0195356 A1
(43) Pub. Date: Aug. 31, 2006

(54) Entertainment venue data analysis system and method

(76) Inventors: Mark Nerenhausen, Davie, FL (US); Catherine Carter, Fort Lauderdale, FL (US); Tammy Gibson, Oakland Park, FL (US); Jordan Gross Richmond, Miami, FL (US)

Correspondence Address: MANUEL VALCACEL;c/o GREENBERG TRAURIG, P.A., 1221 BRICKELL AVENUE, MIAMI, FL, 33131, US

(21) Appl. No.: 11/066,207

(22) Filed: Feb. 25, 2005

(51) Int. Cl. G06Q 30/00

(52) U.S. Cl. 705/14

(57) ABSTRACT

A system and method for analyzing entertainment venue data for improved venue management, comprising conventional computer hardware and including compatible software application for compiling and manipulating event consumer and sales data as well as third party consumer demographic data, including classification of event data into a plurality of event-type clusters, correlation of consumer data and event cluster data, and performing manipulations of said data in response to user queries and displaying query results. In a preferred embodiment, associative query logic database technology is used to create a data cloud of event venue consumer and sales data as well as third-party sourced demographic data.

### BACKGROUND OF THE INVENTION

1. Technical Field

The field of this invention is business intelligence. The present invention relates generally to methods and systems for marketing and sales data analysis for commercial ventures. More specifically, the present invention is an entertainment venue data analysis system and method.

2. Background

Effective use of business data is very important to the successful management of any business. This is no less true for management of entertainment venues such as indoor and outdoor sports arenas, musical and play theaters, performing arts centers, concert halls, stadiums and similar venues. Business data takes many forms, such as financial/sales data, product data, customer data and marketing efforts data, among others. These various types of data are usually stored in different ways, such as one or more databases, spreadsheets, word processing documents, web pages and other forms.

Entertainment venues, such as indoor and outdoor sports arenas, theaters, concert halls, stadiums, performing arts centers and similar venues are currently oftentimes managed without sufficient knowledge regarding consumer demand and related consumer marketing information to maximize the possible revenues for each event and with respect to performing arts centers in particular, to best serve their mission and cultivate their patrons. Marketing efforts for an event often extend needlessly beyond what is necessary to sell-out events and are oftentimes not targeted to the best market of consumers for the particular event.

Various third party sources of consumer marketing data are available with potential applicability with respect to entertainment venues, such as providers of concert audience profiling based on consumer polling. Some systems exist for providing customer demographic data, which use demographics, including socioeconomic and housing data and aggregated consumer demand data at the zip +4 level to classify every U.S. household into one of 50 unique market segments. Each segment is supposed to consist of households that have similar interests, purchasing patterns, financial behavior and demand for products and services. The accuracy and usefulness of such segmentation is less than perfect because it is impossible for each household within a segment to act the same way. While somewhat useful, such systems do not provide a complete data harnessing solution for entertainment venues. Consumer segmentation alone does not accurately correlate or predict entertainment event types preferred by particular consumer segments. For example, it was found that marketing for a doo-wop musical event directed to particular consumer segments thought to correlate with such music over others did not make a significant difference in sales because the primary characteristic attributed to sales of tickets for the particular event was whether the consumer lived in a particular city during a particular time when the music was popular.

Other more venue-specific sources of consumer marketing data for entertainment venues include the venue's own box office and concession sales data, and for performing arts centers in particular, their patron or season-ticket holder data, as well as direct consumer polling at entertainment venues, as well as venue polling via mail or via the Internet. Entertainment venues have the ability, via contact with their customers and patrons when they purchase tickets for events, to gather valuable data that can be harnessed to effectively manage the venue. Box office ticket data can include extensive customer information, including, but not limited to, the customer's name, address, zip code, buyer type (e.g., individual, group, other categories), date of purchase, purchasing channel, (e.g., via telephone, website, or other means), number of tickets purchased, type of ticket purchased, price of ticket purchased, event type, the specific event for which tickets are being purchased, and what other products or services were purchased with the tickets.

Prior targeted marketing methods have involved consumer surveys used to gather and formulate demographic information for the respondents and geodemographic information for market regions. Such methods only provide generalizations, however, assuming that all consumers falling within a particular category have the same taste and make the same purchasing decisions.

Other systems attempt to use past sales history and current data to manage revenue and profit for entertainment events. Such systems have shortcomings, including, among others, not taking into consideration various factors that affect revenues and profit, such as when the event is scheduled, where and to whom the event is marketed, what related goods or services can also be sold at or in connection with an event, and what other events can be effectively marketed when marketing a particular event. Ticket pricing optimization is also usually not utilized to its maximum potential due to incomplete harnessing of available data.

For event venues such as performing arts centers, there is also the need to effectively market to patrons for fundraising purposes and to further specific performing arts missions goals.

Other systems are available that are intended for use by entertainment event venues, providing a management system for customer relationship management, fund raising, subscriptions and ticketing, marketing management and reporting functions. These customer relationship management tools focus on managing the history of a customer's relationship with the venue from the patron's standpoint, and don't provide programming analysis or data aggregation. The present invention is an advancement in entertainment event venue box office data analysis systems and methods.

By using the present invention, entertainment venues can use and analyze data more effectively, including, but not limited to, identifying the geographic distribution of their customers and patrons, tracking the venues' market penetration (ratio of patrons to overall local population) and customer/patron buying patterns, such as timing of purchases, making ticket quality purchase comparisons, identifying purchase preferences and programming clusters that correlate with customer/patron characteristics, as well as identifying crossovers among clusters, analyzing customer/patron projected lifetime values, analyze customers/patrons by type, identifying first-time buyer characteristics, frequency/recovery of purchases, analyzing pricing as well as effective management of customer/patron lists and new customer/patron prospecting.

The present invention utilizes clusters that categorize consumer types and their entertainment preferences to generate a consumer profile. The present invention combines third party consumer demographic research data (demographics, psychographics and geographies) with actual patron and customer data as it relates to events (clusters of events that appeal to a particular group of people, customer purchasing patterns for each event-cluster and crossover of customers among the various clusters) to create culture-based profiling. This allows entertainment venues to correlate consumer characteristics and purchasing behavior to types of events. For example, users of the present invention can harness third party data and their own actual box office data to identify the type of consumer that would or typically does attend an “off-Broadway” event, as well as identify where such consumers live, what newspaper they subscribe to, whether they buy via the Internet or by phone, how far in advance of an event they usually make their ticket purchases, what other events such consumers are interested in attending and what other related products or services such consumers purchase.

Key users of the system are entertainment event venue executives and marketing and sales personnel, although event sponsorship managers, concession managers, brand/audience managers and others are also potential system users that can improve their performance by using the system.

The present invention enables entertainment venues to forecast when events are expected to sell out and can make adjustments to marketing direction and timing accordingly. Audiences for events can be identified, developed and retained. Because the data is gathered from both third party consumer demographic research as well as actual consumer demographic research as well as actual consumer box office data, the system not only tracks historical trends but also predicts future trends, so that marketing pricing and customer relationship management decisions can be made to optimize event attendance, revenues as well as patron support. Venue operators can analyze which event types sell more than others (e.g., does opera sell more than ballet?) and allows for ticket price adjustments as tickets are sold, to maximize sales. By knowing how a consumer that tends to attend a particular type of event purchases his/her tickets (i.e., whether by phone, Internet or other means), the marketing efforts for such events can be focused to reach such consumers in their preferred medium of communication. The consumers most likely to have an interest in attending a particular event can be alerted to upcoming performances and offered tickets and related merchandise or services more efficiently than via mass media advertisements.

### SUMMARY OF THE INVENTION

The present invention provides a system and method for entertainment venues to harness their box office and patron data to maximize revenues and provide entertainment and other products that satisfy patron preferences and also meeting organizational objectives. The present invention comprises software applications that process box office ticket sales data for entertainment events to track and analyze the geographical distribution of event patrons, patron market penetration in the relevant population, buying patterns, purchase preferences, pricing tiers, ticket sales patterns, analysis of sales trends by programming categories or “clusters,” and analysis of patron crossovers between clusters, among other analytics specifically applied to the actual entertainment venue. Users of the system, namely, entertainment venue management personnel, interact with the system via the system graphical user interfaces of which there are several forms, including: (i) an executive view customized for use by executive management providing overall financial summaries, mission critical analysis, productivity analytics and event portfolio analysis; (ii) a market view customized for marketing personnel providing marketing summaries by programming cluster, sales curves, market trigger analytics and performance analytics; and, (iii) a sales view customized for use by sales personnel providing financial summaries, mission critical analytics, sales channel analytics and sales forecasts. The graphical user interfaces, referred to as the “dashboard,” can present data in tabular form and preferably in the form of charts, graphs, and other graphical images and customized reports can be generated. The system enables more effective and efficient marketing and sales of entertainment events by providing tools to identify purchasing patterns as influenced by various factors and optimize marketing and sales efforts based on such patterns. In a preferred embodiment, the invention utilizes associative query logic database technology to provide more effective data harnessing, eliminating the need for online analytic processing (OLAP) cubes or the need for a data warehouse. A data cloud, as opposed to OLAP cubes, eliminates redundancy, hierarchies and aggregation. This permits users to analyze data based on user customized criteria more quickly and less expensively than traditional relational database technology, and data from disparate sources and systems is easily integrated.

The data cloud is a non-redundant, non-pre-aggregated associative database that resides in the computer's primary memory. Because the data is not pre-aggregated, it is also possible to analyze and interact with the “data cloud” from any piece of data, at any level, and move in any dimension from there. Reverse answers to queries are also producible. Because data can be pulled from any source, it is simple to combine and interact with business information from multiple sources, reducing the need to gather data from multiple voluminous reports.

Usually, different software products are needed to collect and use the data in the various forms that such data exists. Most systems for data management focus on simplifying data input and storage rather than ease of data interpretation. In order to query the data a structured language in a form that the computer understands must be used and new forms must be created that cover all available data despite such data being in different systems and forms.

In a relational database, records are broken apart to reduce redundancy and key fields are used to put the record back together at the same time they are used. Associative databases, by contrast, create a database as data is loaded from various data sources, requiring significantly less space and allowing the user maximum flexibility and information when working with the database. The system's database structure also supports variable group and drill down charting functions, whereby charting of data can be easily done for each variable group specified (such as by customer, time period, product or other variable groups). Drill down groups are sequential groups of data that can be displayed in a chart sequentially as chart specifications are narrowed or broadened. For example, a chart showing sales over a year may show bars for each month's sales. If a single month is selected the chart displays sales broken down for the four weeks in the selected month, or the individual customers that made purchases during such period, or other desired data criteria. The system allows any variables to be grouped together and variables within the groups can be changed easily without requiring modifications to the chart definition as is the case with defined hierarchy structured databases. Additionally, different system user access levels can be established. Users can make system data queries easily by clicking on data values or clicking within chart representation of data.

### BRIEF DESCRIPTION OF THE DRAWINGS

FIG. 1 depicts a sample system user data table displaying various data analysis tables organizing data by various criteria.

FIG. 2 depicts a sample system user screen displaying a table of event data.

FIG. 3 depicts a sample system user screen displaying a table of event sales data categorized by ticket qualities.

FIG. 4 depicts a sample system user screen displaying a table of event sales data categorized by buyer categories.

FIG. 5 depicts a sample system user screen displaying a table of event sales data categorized by event type clusters.

FIG. 6 depicts a sample system user screen displaying a table of event sales data categorized by venue.

FIG. 7 depicts a sample system user displaying a table of market penetration data categorized by city.

FIG. 8 depicts a sample system user sales screen displaying sales data charted by various criteria.

FIG. 9 depicts a sample system user buyer details screen displaying buyer demographic data charted by various criteria.

FIGS. 10 and 10a depicts a sample system user box office reports screen displaying box office data charted by various criteria.

FIG. 11 depicts a sample system user group sales data screen displaying group sales data screen displaying group sales data organized by various criteria.

FIG. 12 depicts a sample system executive review user screen displaying various financial mission criteria analysis and productivity analytics data organized by various criteria.

FIG. 13 depicts a sample system market view user screen displaying various marketing performance and market trigger data organized by various criteria.

FIG. 14 depicts a sample system sales view user screen displaying various financial mission critical analytics and sales channel data organized by various criteria.

FIG. 15 depicts a list of sample event clusters with a description and examples of events falling within each cluster.

FIG. 16 depicts a sample of system hardware.

### DESCRIPTION OF A PREFERRED EMBODIMENT OF THE INVENTION

According to a preferred embodiment hereof, the present invention is a system and method for analyzing entertainment venue box office data for improved venue management. The system comprises conventional computer hardware, including a main processor, a display device, such as a monitor or printer, an input device such as a keyboard, and a data storage device, including compatible system software applications run for compiling and manipulating event box office consumer and sales data as well as third party sourced consumer demographic data, including classification of event data into a plurality of event-type clusters and correlation of consumer data and event cluster data, performing calculations and displaying graphically the results of such data manipulations and calculations. The invention is not limited to any particular form of computer hardware and can be adapted for use in various hardware embodiments without departing from the scope of the invention. In a preferred embodiment, the system utilizes associative query logic database technology to provide more effective data harnessing by creating a data cloud compilation of said data. Users of the system, namely, most likely entertainment venue management personnel, interact with the system via the system graphical user interfaces of which there are several forms, including: (i) an executive view customized for use by executive management providing overall financial summaries, mission critical analysis, productivity analytics and event portfolio analysis; (ii) a market view customized for marketing personnel providing marketing summaries by programming cluster, sales curves, market trigger analytics and performance analytics; and, (iii) a sales view customized for use by sales personnel providing financial summaries, mission critical analytics, sales channel analytics and sales forecasts. The graphical user interfaces can present data in tabular form and preferably in the form of charts, graphs, and other graphical images and customized reports can be generated. The system enables more effective and efficient marketing and sales of entertainment events by providing tools to identify purchasing patterns as influenced by various factors and optimize marketing and sales efforts based on such patterns.

The method of the present invention in a preferred embodiment comprises the following steps: gathering event venue box office consumer and sales data; obtaining third party consumer demographic data; compiling said event venue box office consumer and sales office data and third party consumer demographic data into a searchable computer database, whereby said data arranged as a data cloud is available without hierarchies or aggregation for maximum data manipulation, classifying said data into a plurality of event type clusters; correlating said consumer data and event cluster data; performing calculations using said data of said database in response to user queries; and displaying results of such queries to said users. In a preferred embodiment of the method, the compiling step is accomplished using associative query logic database technology and user query results are displayed graphically.

System Software Applications

The system's functionality is driven by its software applications, which include database management applications, query processing applications and graphical user interface applications.

Database and Data Sources

The database technology used in the present invention includes various embodiments such as structured query language relational databases and other known technologies. In a preferred embodiment the system uses associative query logic database technology to maximize data drill down capabilities. Data is coordinated and arranged into a “data cloud” which is a non-redundant, non-preaggregated associative database associative database. Because the data is not pre-aggregated, it is possible to analyze and interact with the “data cloud” from any piece of data at any level and more in any dimension from there. Use of such database technology increases data harnessing capabilities by eliminating redundancy, hierarchies and aggregation of data pieces.

The data sources used by the system include the entertainment venue consumer and sales data or data provided by outside ticket sales providers, as noted previously, such data includes data gathered from box office transactions of sales of tickets to consumer/patrons as well as consumer/patron polling data obtained by venue polling of event attendees at the entertainment venues as well as via mail, phone and email. The data includes extensive customer/patron information, including, but not limited to, the customer's/patron's name, address, zip code, buyer type (e.g., individual, group, or other category), data of purchase, purchasing channel (e.g., via telephone, website or other means, number of tickets purchased, type of ticket purchased, price of ticket purchased, event type, the specific event for which tickets are being purchased, method of payment, what other products or services were purchased with the tickets as well customer/patron responses to specific survey questions. Entertainment events can include rock or other musical concerts, plays, Broadway shows, performance art, circuses, trade shows, comic shows, lectures, competitions (sports or other), or other presentations. The gathering of such detailed data for each event season allows analysis and development of seasonal sales curves, and analysis of purchasing patterns by ticket quality, consumer type, event type, marketing period length and methods used, and other user designated criteria. The effectiveness of marketing efforts can be tracked and adjusted for improved effectiveness so that they are directed to the consumers and trade channels most likely to result in sales, timing the marketing and sales period lengths as well as making ticket-type and price allocations based on analysis of the data so that venues can maximize the revenues for an event. Venues can track as the best seats sell for an event and adjust pricing based on demand.

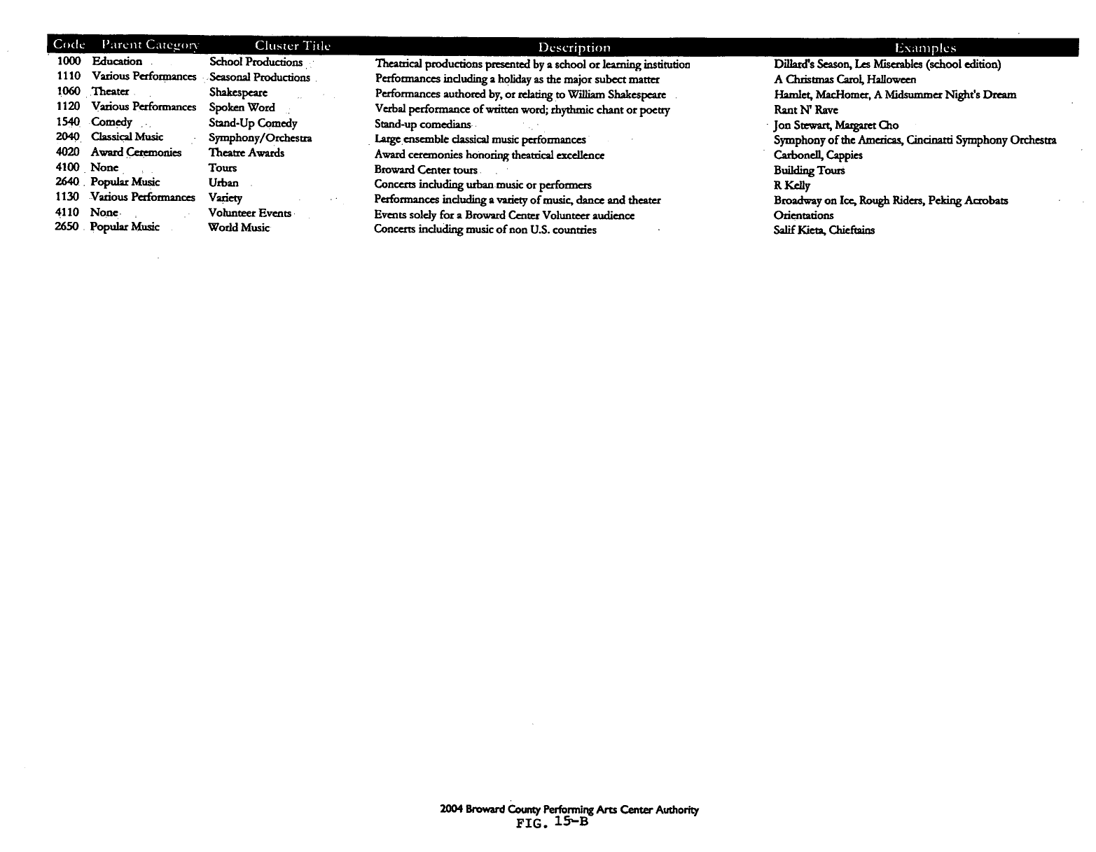

The system also categorizes data into a plurality of event-type programming clusters, which correlate to a plurality of consumer-type clusters. FIG. 15 depicts a list of sample event clusters with a description of each and examples of events falling within each cluster. Third-party sourced consumer demographic research data (which can include demographics, psychographic and geographies) is also incorporated into the system database even if provided in disparate formats, due to the system's easy to use associative query logic database technology as utilized in a preferred embodiment. Third party data sources can include the census, Equifax and other credit reporting data sources as well as Microvision and other commercial providers.

The associative query logic database utilizing a data array or cloud allows event venues to compare data from various events having different characteristics, such as event length, type, pricing, and other characteristics, normalizing the data to correlate to common parameters and then chart the results for comparison purposes.

The first step in configuring the invention is the transformation of data into the system via a data transformation process. This process requires custom analyzation of data, transforming that data to meet specific field requirements within the invention and optimizing that data before it enters the system. After the administrator has performed adequate data preparation, the system is ready to run a script which will acquire system data, perform associative joins between data tables and finally construct the data cloud of which all analytics stem. This last process of acquiring system data via a script represents a “snapshot in time” of all data acquired and therefore must be executed as often as system users require up-to-date information.

Query Processing

System users can formulate queries of system data to answer all kinds of questions regarding entertainment event sales. The system selects and graphically displays data responsive to user queries. For example, users can query the system to display sales of event tickets over a particular period of time. The system will provide a graphical representation of the sales curve in response. Events can be compared to each other in terms of sales performance and other characteristics and events can be further compared within event clusters and from cluster to cluster. For performing arts centers, events can be analyzed and compared as to the extent to which they further mission goals as well as to their profitability. Ticket sales and trends can be tracked on a virtually real-time basis. Data is provided to users selected and arranged differently depending on the type of user. For example, the system's graphical user interfaces as discussed below, provide particular data in its executive user screen, other data in the marketing user screen and still other data in its salesperson user screen, to best address the data needs of each type of user. The system's data cloud technology permits system applications to quickly and easily retrieve data responsive to user queries.

Graphical User Interface

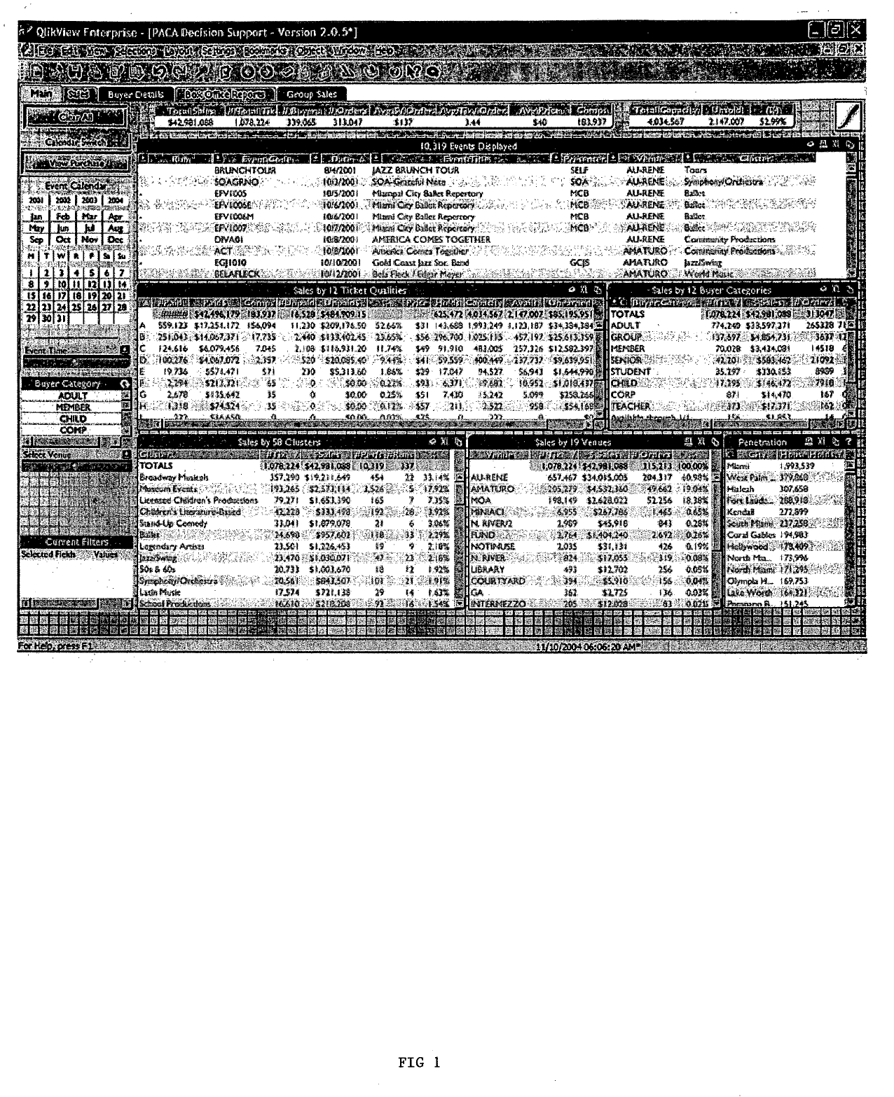

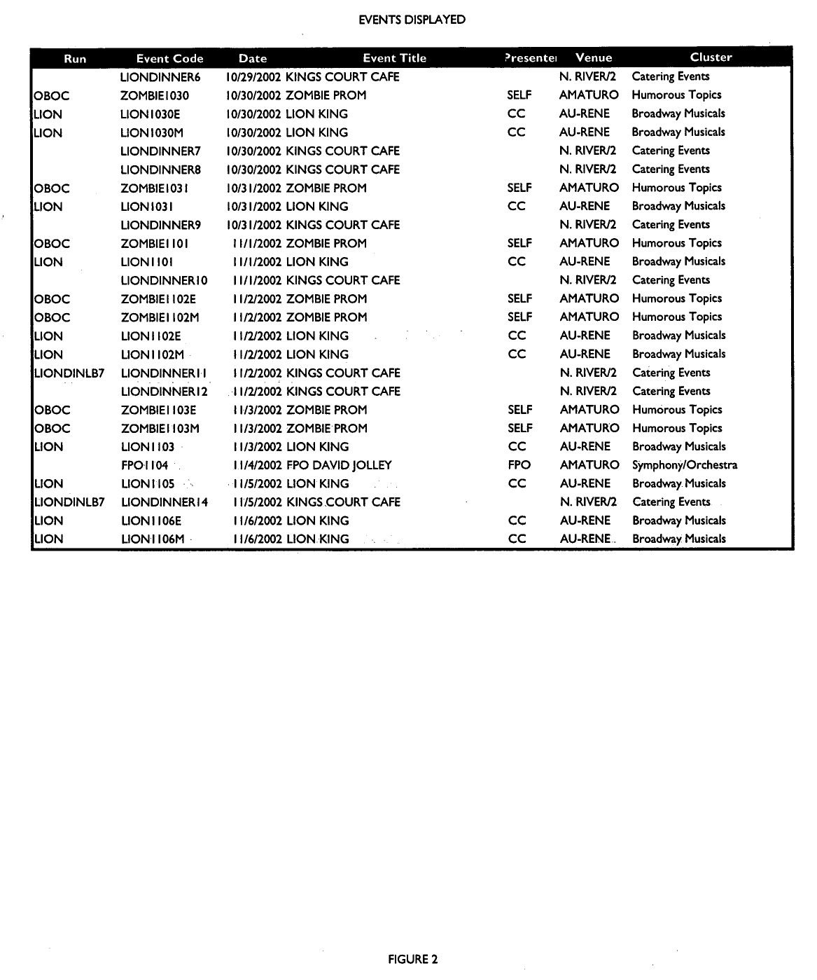

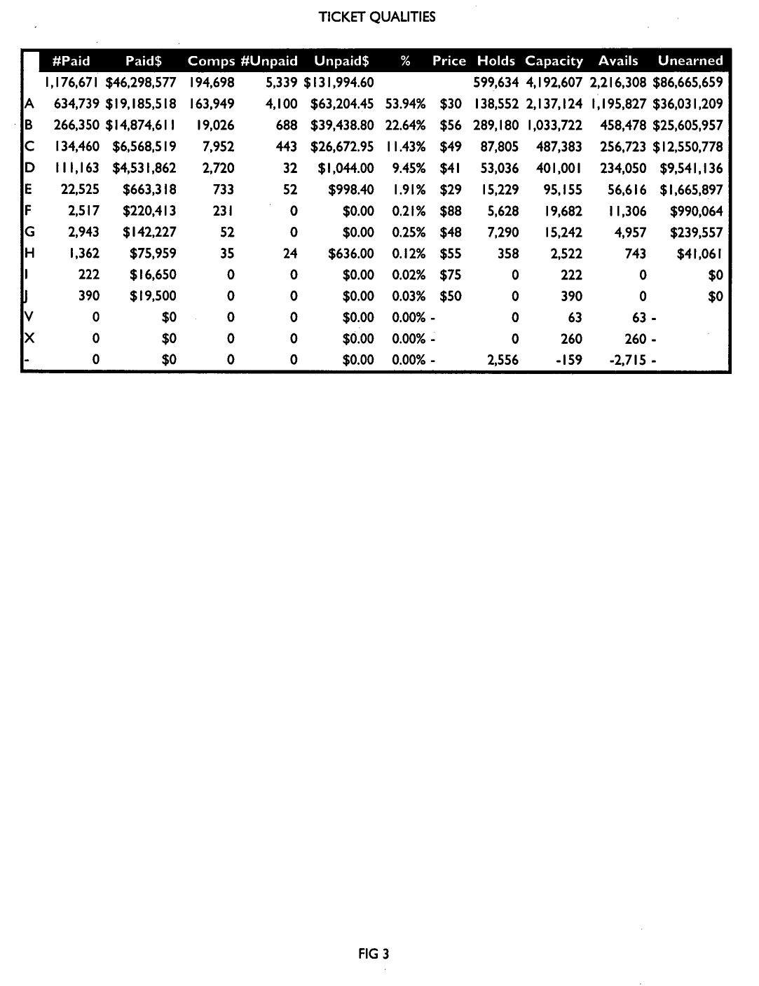

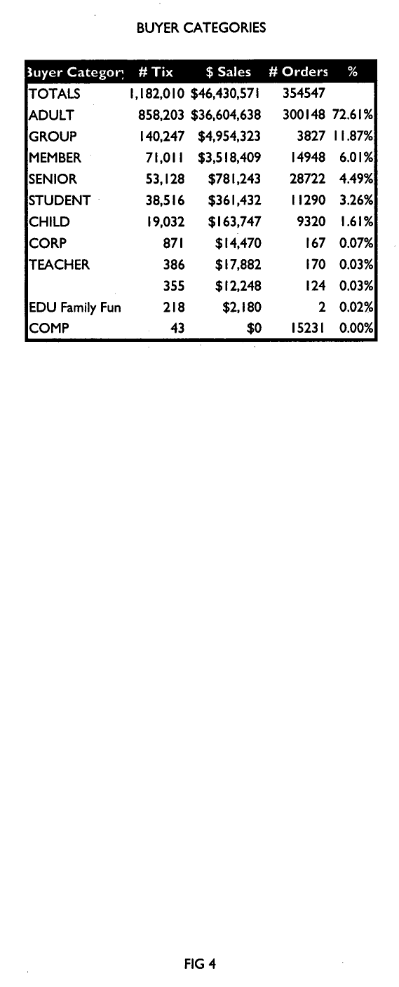

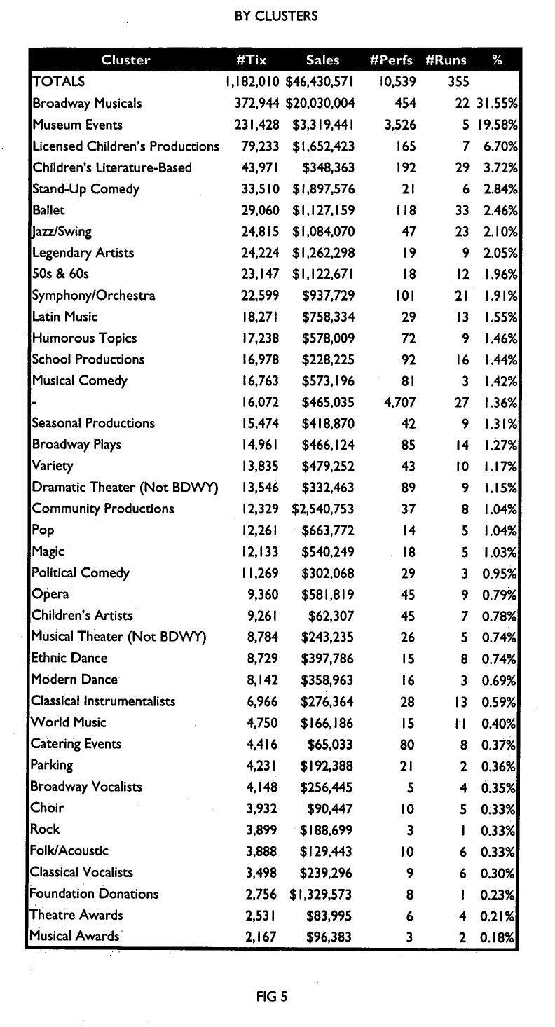

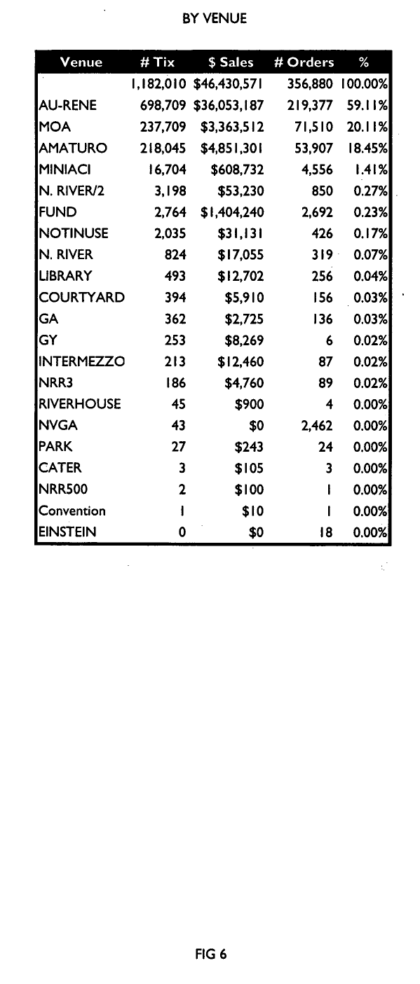

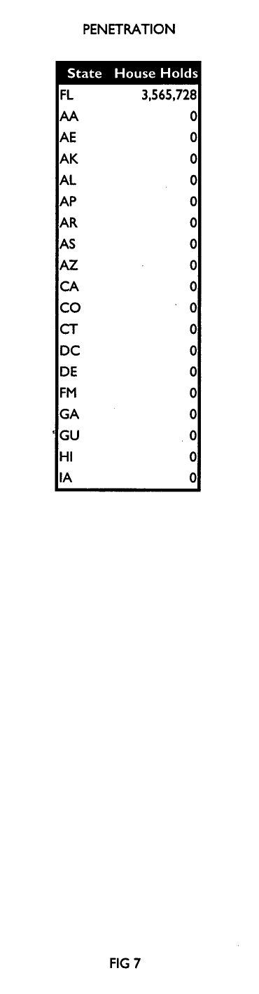

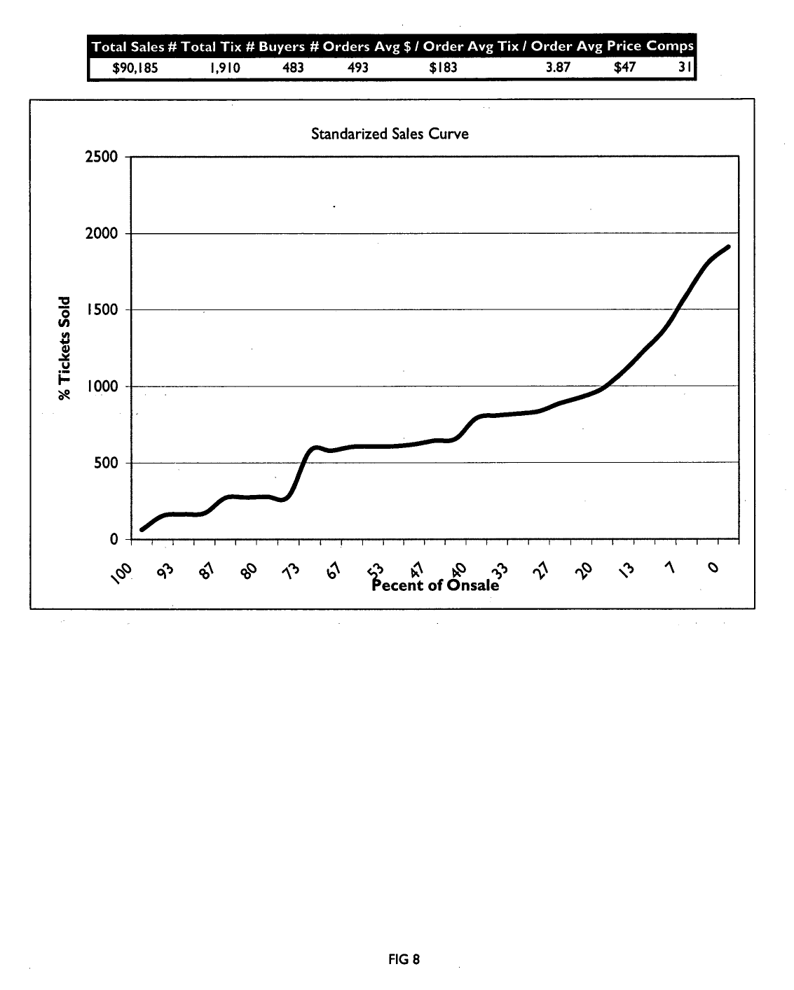

FIGS. 1-14 depict representative samples of the system's graphical user interface screens.

Referring now to FIG. 1, which depicts a sample system main screen with multiple tables of data organized by various user definable criteria. Subscreens include a sales screen, a buyer details screen, a box office reports screen and a group sales screen. Overall aggregate sales data is presented at the top, including total sales, total number of tickets sold, total number of buyers, total number of orders, average order prices, as well as a comparison of total seat capacity and total unsold seat capacity. The main screen also provides a table of events organized by date, event title, presenter, venue and event and cluster; tables of sales data categorized by ticket qualities, buyer categories, event clusters, and by venues. A calculation of the venue's market penetration on a per city basis is also included. The screen also provides an event calendar with options to select event time and venue. There is also a buyer category and miscellaneous selector venues at the left side of each screen and a window indicating the data fillers currently in use. The individual tables presented in FIG. 1 are presented individually in FIGS. 2-7. FIG. 8 depicts a sample sales screen, showing a graph of ticket sales data plotted by sales channel and by percent of on-sale period elapsed. Total sales data is provided above the chart. Additional data charts can be selected, including, without limitation, sales curves by weeks, sales by event time, sales by time, day and buyer, as well as weekly sales reports with ticket counts by event cluster, tickets sold by event, sales curve by event title, number of tickets sold by purchasing channel and percentage of tickets sold by purchasing channel.

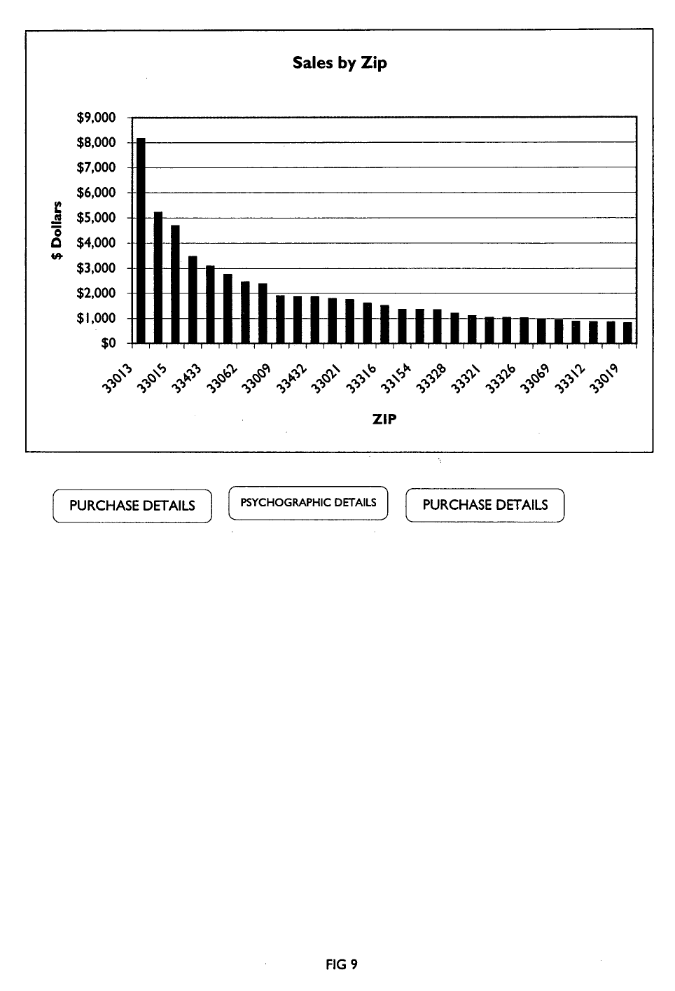

FIG. 9 depicts a sample system user buyer details screen displaying buyer demographic data charted by various criteria. Various data charts can be selected, including, but not limited to, charts for buyer purchase details, buyer address details, sales by buyer zip code, county or state, buyer zip code mapping, buyer data for selected events, and buyer-type cluster data.

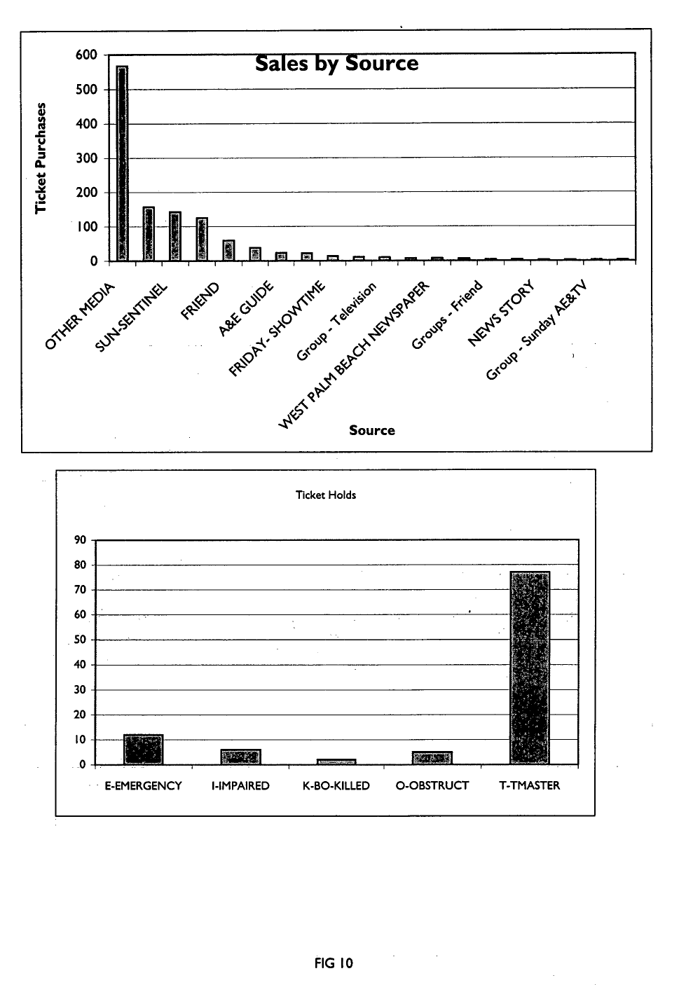

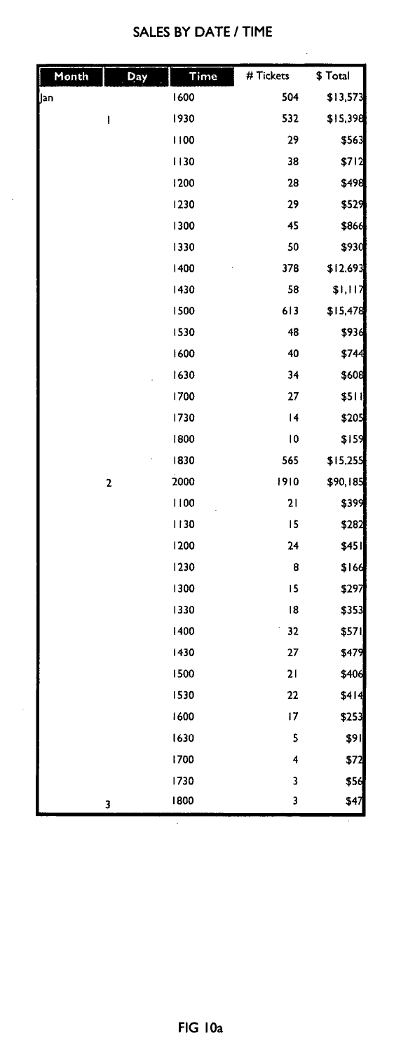

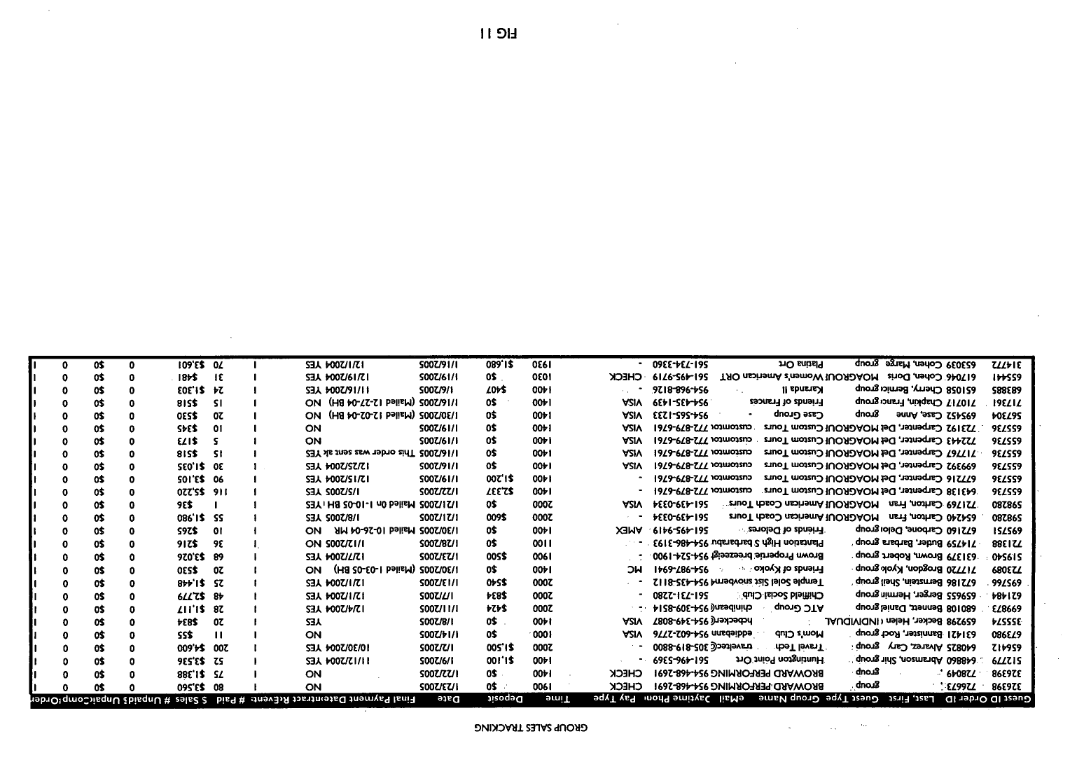

FIGS. 10 and 10a depict sample system user box office report screens displaying box office data charted by various criteria. The chart shown in FIG. 10a tracks sales of tickets for a particular event by time, in the form of a month/day/hour timeline. Other charts that can be selected, include, but are not limited to, event sales summaries, sales by source, number of tickets sold per sales channel, payment type reports, seat locations by event/guest and individual buyer purchase details.

FIG. 11 depicts a sample system user group sales data screen displaying group sales data screen displaying group sales data organized by various criteria. The table shown in FIG. 11 depicts group buyer purchase details by buyer I.D. number, names of group members, group name, contact information, payment type, date and time of purchase and balance owed. Other charts that can be selected include, but are not limited to, guest lists by event, available tickets by day, contact lists and lists of guests with no orders.

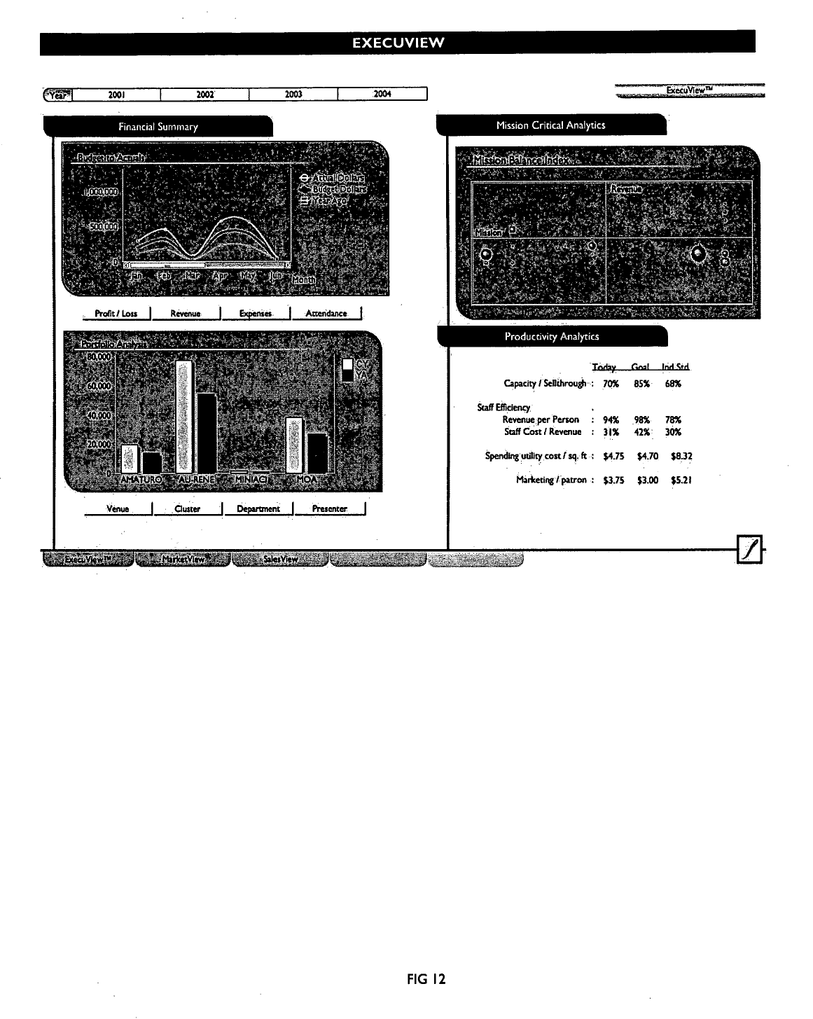

FIG. 12 depicts a sample system executive view user screen displaying various financial mission criteria analysis and productivity analytics data organized by various criteria. The charts and analytics displayed in FIG. 12 including yearly financial summaries showing budgeted amounts compared to actual dollars spent and compared to prior years. Profit/loss, revenue, expenses and attendance data can also be charted and compared from time period to time period. Event venue performance is also compared by venue, event cluster, department and presenter. Executives are also provided with a graphical representation of a mission balance index, tracking and comparing events as to how they further the venue's mission and as to how they generate revenues. Venue productivity is also charted, showing actual, goal and industry standard levels for venue capacity/sell-through, staff efficiency (revenue generated per person, and staff cost/revenues), utility costs per square foot and marketing expenditures per patron.

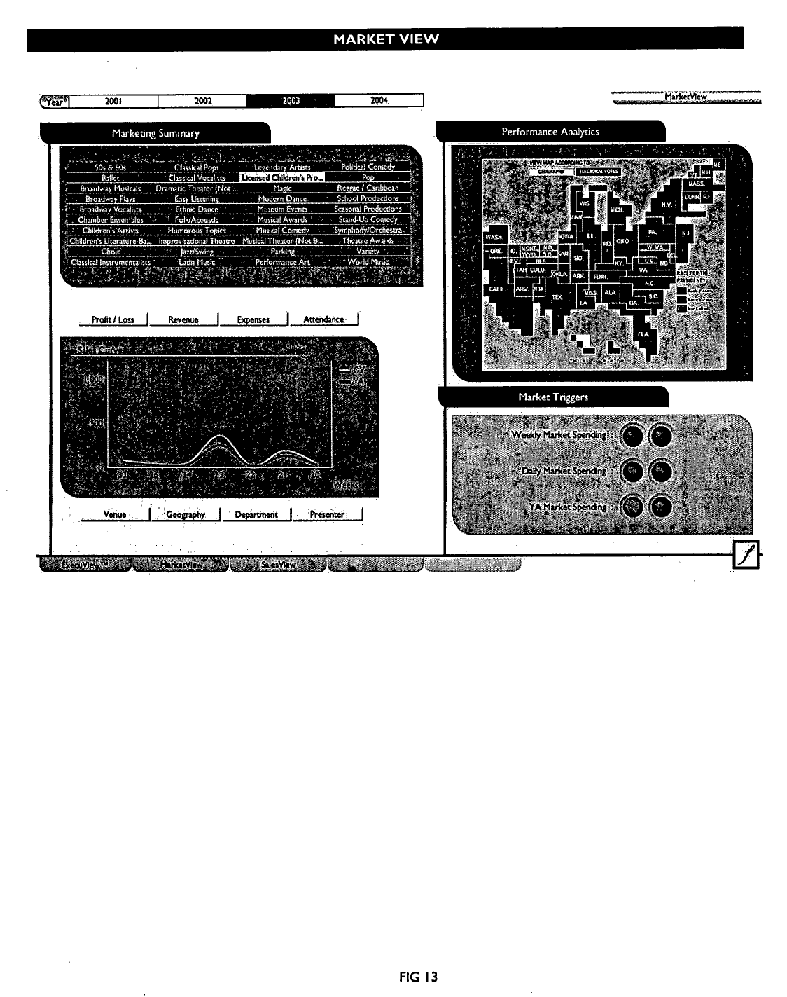

FIG. 13 depicts a sample system market view user screen displaying various marketing performance and market trigger data organized by various criteria. The screen provides market summaries for each event-type cluster, including profit/loss, revenue, expense and attendance data charting, sales curves showing sales over time, including comparisons with prior years. Marketing performance analytics such as market penetration charts and weekly, daily, and historical marketing statistics are also charted.

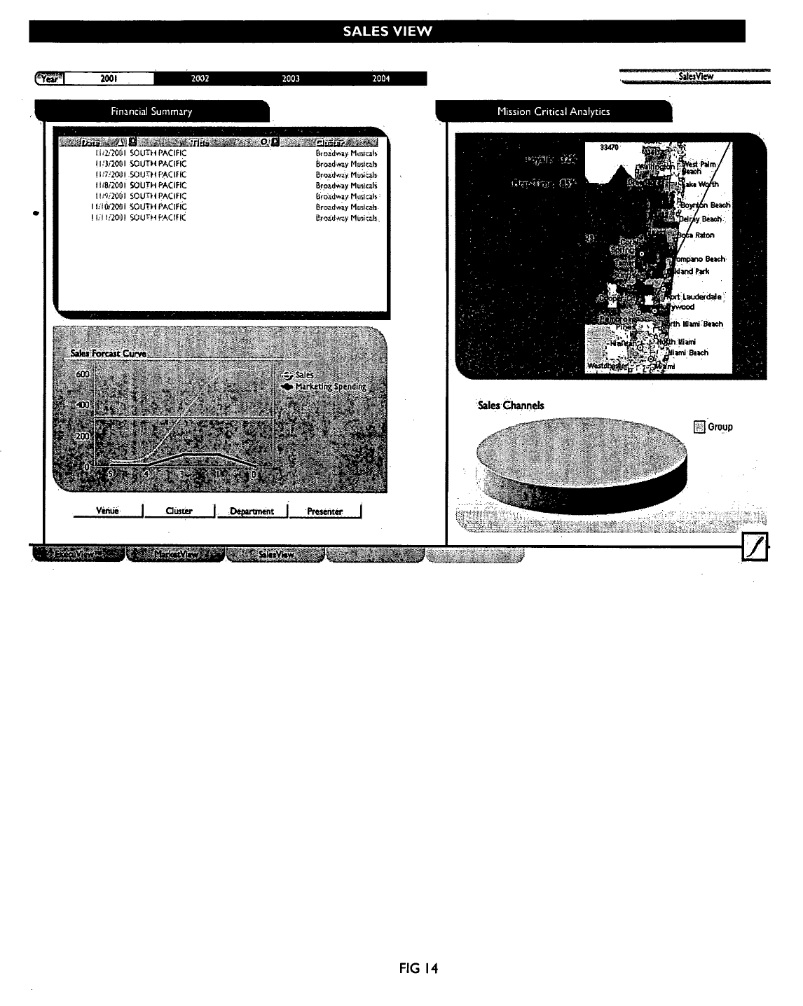

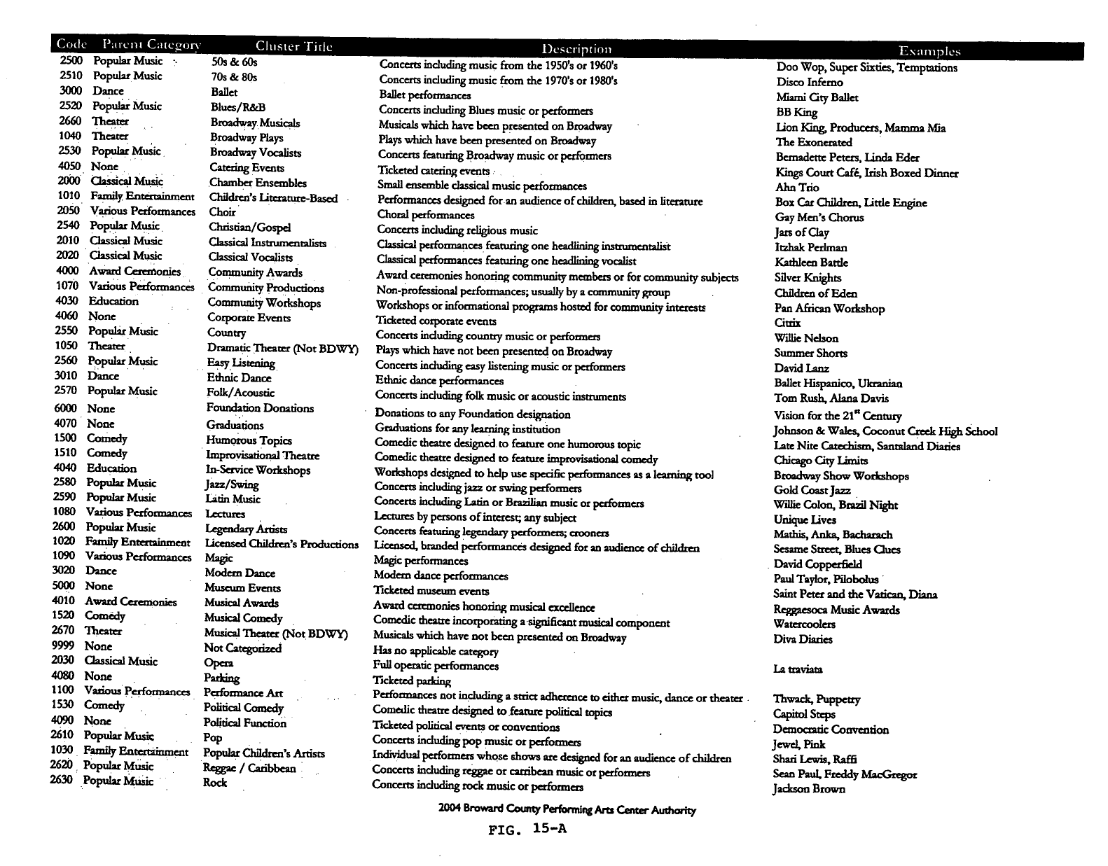

FIG. 14 depicts a sample system sales view user screen displaying various financial mission critical analytics and sales channel data organized by various criteria. The salesview screen presents financial summary charts showing sales forecast curves, with comparisons of marketing expenditures and sales over the same time periods, charts of comparing the sales by sales channels used, and charting percentages and locations of loyal/repeat patrons and first-time buyers by event.

The system includes color-coded directives which translate to direct action steps. The invention also provides detailed marketing suggestions which include but are not limited to specific strategy, tool choices, and suggested spending; said suggestions are based on prior configured objectives.

The system includes a comprehensive technical and user guide. These guides can be used to install, configure and setup the system. Additionally, the user guide includes an overview and detailed instructions regarding each of the specific tools, interface mechanisms, and suggested use. Said guides include comprehensive indices and glossaries as well.

System Hardware

The system can be provided in various forms, including, but not limited to, via an Internet website where users subscribe and log-in to use the system applications accessed via the site. The users have a suitable Internet browser and Internet access and use their own computer hardware to access and use the system. The system software applications can also be provided as software object code saved on suitable media, such as cd-rom or other media format, for installation at user computer work stations, or in a downloadable format, or other formats.

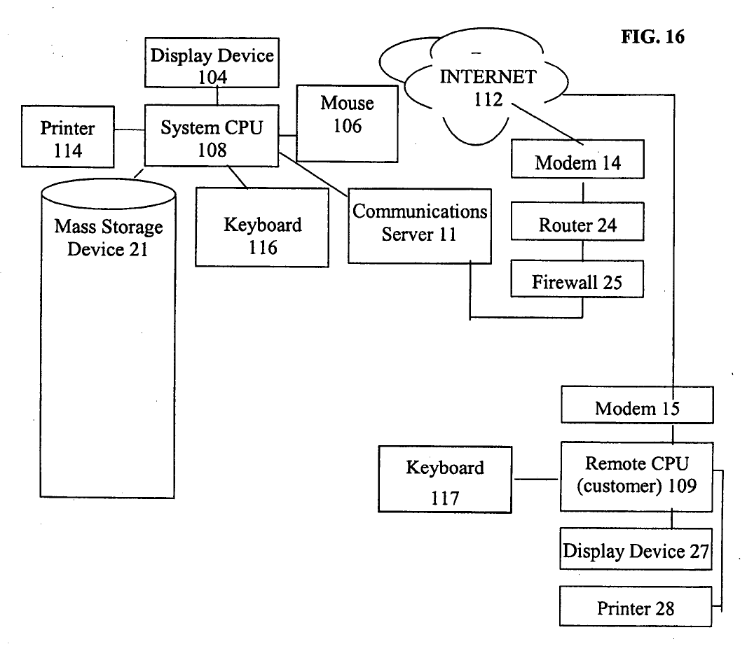

FIG. 16 depicts sample system hardware components, which are known in the art, both at the system and at the user end. As noted previously, the invention is not limited to any particular computer hardware embodiment. The computer system 108 comprises input and output devices, as is well-known in the art. For example, the computer system 108 preferably comprises a display screen or monitor 104, a keyboard 116, a printer 114, a mouse 106, etc. The computer system 108 is preferably connected to the Internet 112 that serves as the presently preferred communications medium. The Internet 112, as previously discussed, comprises a global network of networks and computers, public and private. A storage device 21 stores data, and for Internet-based embodiments, a communications server 11 is utilized as well as a modem 14 router 24 and firewall 25. The Internet 112 is the preferable connection method by system users in preferred embodiments of the present invention. The user's computer can have similar features as shown in FIG. 1. A user accesses the invention via any standards-compatible web browser. The Internet address can be bookmarked for convenience. Each user provides unique name and password credentials to access the invention; these credentials restrict or grant access to elements within the invention as configured.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. A computerized system for analyzing entertainment venue data for improved venue management, comprising:
a computer processor,
a display device, an input device and a data storage device, each communicating with said computer processor, and
compatible system software applications run for compiling and manipulating event venue consumer and sales data as well as third party sourced consumer demographic data, including classification of event data into a plurality of event-type clusters and correlation of consumer data and event cluster data, performing calculations and displaying graphically the results of such data manipulations and calculations.

2. The system of claim 1, wherein the system software applications and database utilize associative query logic database technology to provide more effective data harnessing by creating a data cloud compilation of said data.

3. The system of claim 1, wherein said software applications provide a graphical user interface customized for use by executive management providing overall financial summaries, mission critical analysis, productivity analytics and event portfolio analysis.

4. The system of claim 1, wherein said software applications provide a graphical user interface customized for use by marketing personnel providing marketing summaries by event cluster, sales curves, market trigger analytics and performance analytics.

5. The system of claim 1, wherein said software applications provide a graphical user interface customized for use by sales personnel providing financial summaries, mission critical analytics, sales channel analytics and sales forecasts.

6. A computerized method for analyzing entertainment venue data for improved venue management, comprising the steps of:
gathering event venue consumer and sales data,
obtaining third party consumer demographic data,
compiling said event venue consumer and sales office data and third party consumer demographic data into a searchable computer database,
classifying said data into a plurality of event-type clusters,
correlating said consumer data and event cluster data,
performing calculations using said data of said database in response to user queries,
and displaying results of such queries to said users.

7. The method of claim 6, whereby said data is arranged as a data cloud for maximum data manipulation.

8. The method of claim 6, wherein the compiling step is accomplished using associative query logic database technology.

9. The method of claim 6, wherein user query results are displayed graphically.
